(19) United States
(12) Patent Application Publication
(10) Pub. No.: US 2024/0094365 A1
(43) Pub. Date: Mar. 21, 2024

(54) CONTAMINATION DETECTION APPARATUS

(71) Applicant: DENSO CORPORATION, Kariya-city (JP)

(72) Inventor: Yasuhiro SUZUKI, Kariya-city (JP)

(21) Appl. No.: 18/518,249

(22) Filed: Nov. 22, 2023

Related U.S. Application Data
(63) Continuation of application No. PCT/JP2022/021452, filed on May 25, 2022.

(30) Foreign Application Priority Data
May 28, 2021 (JP) 2021-090346

(51) Int. Cl. G01S 7/497; G01S 17/931

(52) U.S. Cl. CPC G01S 7/497; G01S 17/931; G01S 2007/4975

(57) ABSTRACT

A contamination detection apparatus acquires distance-measurement point information from a laser radar apparatus that generates the distance-measurement point information that indicates a distance-measurement point distance to a distance measurement point and light reception intensity of detected laser light. The contamination detection apparatus acquires scattered light information that indicates scattered light intensity of scattered light from a scattered light sensor that detects scattered light generated by the laser light scattering inside the casing as a result of emission of the laser light by the laser radar apparatus. The contamination detection apparatus executes contamination detection that detects contamination of the optical window based on the scattered light intensity indicated by the scattered light information. The contamination detection apparatus prohibits execution of the contamination detection when the light reception intensity is equal to or greater than an intensity threshold set based on the distance-measurement point distance corresponding to the light reception intensity.

### CROSS-REFERENCE TO RELATED APPLICATION

The present application is a continuation application of International Application No. PCT/JP2022/021452, filed on May 25, 2022, which claims priority to Japanese Patent Application No. 2021-090346, filed on May 28, 2021. The contents of these applications are incorporated herein by reference in their entirety.

### BACKGROUND

### Technical Field

The present disclosure relates to a contamination detection apparatus.

### Related Art

A contamination detection apparatus that detects attachment of contaminants on a laser radar apparatus is known. The contamination detection apparatus determines whether a contaminant is attached on the laser radar apparatus based on an amount of time from emission of laser light to detection of reflected light and intensity of the reflected light.

### SUMMARY

An aspect of the present disclosure provides a contamination detection apparatus that acquires distance-measurement point information from a laser radar apparatus that: emits laser light toward outside by transmitting the laser light through an optical window from inside a casing; detects the laser light that arrives inside the casing after being reflected at a distance measurement point; and generates the distance-measurement point information that indicates a distance-measurement point distance that is a distance to the distance measurement point and light reception intensity that is intensity of the detected laser light. The contamination detection apparatus acquires scattered light information that indicates scattered light intensity of scattered light from a scattered light sensor that detects scattered light that is generated by the laser light scattering inside the casing as a result of emission of the laser light by the laser radar apparatus. The contamination detection apparatus executes contamination detection that detects contamination of the optical window based on the scattered light intensity indicated by the scattered light information. The contamination detection apparatus prohibits execution of the contamination detection when the light reception intensity is equal to or greater than an intensity threshold that is set based on the distance-measurement point distance corresponding to the light reception intensity.

### BRIEF DESCRIPTION OF THE DRAWINGS

In the accompanying drawings:

FIG. 1 is a block diagram illustrating a configuration of a laser radar apparatus according to an embodiment of the present disclosure;

FIG. 2 is a flowchart illustrating a window-surface contamination detection process performed by a control unit of the laser radar apparatus of FIG. 1;

FIG. 3 is a diagram illustrating an intensity threshold map stored in the control unit;

FIG. 4 is a diagram illustrating a transmittance map and a contamination level map stored in the control unit;

FIG. 5 is a diagram illustrating a first region, a second region, and a third region in a scanning angle range in which a laser light is scanned by a light projecting unit unit of the laser radar apparatus of FIG. 1;

FIG. 6 is a flowchart illustrating a first contamination detection process of FIG. 2; and

FIG. 7 is a flowchart illustrating a second contamination detection process of FIG. 2.

### DESCRIPTION OF THE EMBODIMENTS

JP 2005-010094 A describes a technology in which, when an amount of time from emission of laser light to detection of reflected light is shorter than a predetermined amount of time and intensity of the reflected light is equal to or greater than a predetermined intensity, a contaminant is determined to be attached on the laser radar apparatus.

As a result of detailed examination by the inventors, an issue has been found in that, in the technology described in JP 2005-010094 A, a contaminant may be determined to be attached on the laser radar apparatus regardless of the contaminant not being attached.

The present disclosure improves determination accuracy of contamination detection.

A first exemplary embodiment of the present disclosure provides a contamination detection apparatus including: a distance-measurement point acquiring unit that is configured to acquire distance-measurement point information from a laser radar apparatus that is configured to: emit laser light toward outside by transmitting the laser light through an optical window from inside a casing; detect the laser light that arrives inside the casing after being reflected at a distance measurement point; and generate the distance-measurement point information that indicates a distance-measurement point distance that is a distance to the distance measurement point and light reception intensity that is intensity of the detected laser light; a scattered-light information acquiring unit that is configured to acquire scattered light information that indicates scattered light intensity of scattered light from a scattered light sensor that is configured to detect scattered light that is generated by the laser light scattering inside the casing as a result of emission of the laser light by the laser radar apparatus; a contamination detection unit that is configured to execute contamination detection that detects contamination of the optical window based on the scattered light intensity indicated by the scattered light information; and an intensity prohibiting unit that is configured to prohibit the contamination detection unit from executing the contamination detection when the light reception intensity is equal to or greater than an intensity threshold that is set based on the distance-measurement point distance corresponding to the light reception intensity.

The contamination detection apparatus according to the first exemplary embodiment configured in this manner is capable of suppressing occurrence of a situation in which the contamination detection unit makes an erroneous determination as a result of laser light that is reflected by a highly reflective object present near the laser radar apparatus entering inside the casing, and improving determination accuracy of the contamination detection.

A second exemplary embodiment of the present disclosure provides a contamination detection apparatus including: a distance-measurement point acquiring unit that is configured to acquire distance-measurement point information from a laser radar apparatus that is configured to: emit laser light toward outside by transmitting the laser light through an optical window from inside a casing; detect the laser light that arrives inside the casing after being reflected at a distance measurement point; and generate the distance-measurement point information that indicates a distance-measurement point distance that is a distance to the distance measurement point and light reception intensity that is intensity of the detected laser light; a scattered-light information acquiring unit that is configured to acquire scattered light information that indicates scattered light intensity of scattered light from a scattered light sensor that is configured to detect scattered light that is generated by the laser light scattering inside the casing as a result of emission of the laser light by the laser radar apparatus; a contamination detection unit that is configured to execute contamination detection that detects contamination of the optical window based on the scattered light intensity indicated by the scattered light information; and an background-light prohibiting unit that is configured to determine whether a background-light prohibiting condition is met, the background-light prohibiting condition being set in advance and indicating that an amount of background light entering inside the casing from the outside is large, and prohibit the contamination detection unit from executing the contamination detection when the background-like prohibiting condition is met.

The contamination detection apparatus according to the second exemplary embodiment configured in this manner is capable of suppressing occurrence of a situation in which the contamination detection unit makes an erroneous determination as a result of background light entering inside the casing from outside the casing, and improving determination accuracy of the contamination detection.

A third exemplary embodiment of the present disclosure provides a contamination detection system including: a processor; a non-transitory computer-readable storage medium; and a set of computer-executable instructions stored in the computer-readable storage medium that, when read and executed by the processor, cause the processor to implement: acquiring distance-measurement point information from a laser radar apparatus that is configured to: emit laser light toward outside by transmitting the laser light through an optical window from inside a casing; detect the laser light that arrives inside the casing after being reflected at a distance measurement point; and generate the distance-measurement point information that indicates a distance-measurement point distance that is a distance to the distance measurement point and light reception intensity that is intensity of the detected laser light; acquiring scattered light information that indicates scattered light intensity of scattered light from a scattered light sensor that is configured to detect scattered light that is generated by the laser light scattering inside the casing as a result of emission of the laser light by the laser radar apparatus; executing contamination detection that detects contamination of the optical window based on the scattered light intensity indicated by the scattered light information; and prohibiting execution of the contamination detection when the light reception intensity is equal to or greater than an intensity threshold that is set based on the distance-measurement point distance corresponding to the light reception intensity.

The contamination detection system according to the third exemplary embodiment configured in this manner is capable of suppressing occurrence of a situation in which the contamination detection unit makes an erroneous determination as a result of laser light that is reflected by a highly reflective object present near the laser radar apparatus entering inside the casing, and improving determination accuracy of the contamination detection.

A fourth exemplary embodiment of the present disclosure provides a contamination detection method including: acquiring distance-measurement point information from a laser radar apparatus that is configured to: emit laser light toward outside by transmitting the laser light through an optical window from inside a casing; detect the laser light that arrives inside the casing after being reflected at a distance measurement point; and generate the distance-measurement point information that indicates a distance-measurement point distance that is a distance to the distance measurement point and light reception intensity that is intensity of the detected laser light; acquiring scattered light information that indicates scattered light intensity of scattered light from a scattered light sensor that is configured to detect scattered light that is generated by the laser light scattering inside the casing as a result of emission of the laser light by the laser radar apparatus; executing contamination detection that detects contamination of the optical window based on the scattered light intensity indicated by the scattered light information; and prohibiting execution of contamination detection when the light reception intensity is equal to or greater than an intensity threshold that is set based on the distance-measurement point distance corresponding to the light reception intensity.

The contamination detection method according to the fourth exemplary embodiment configured in this manner is capable of suppressing occurrence of a situation in which the contamination detection unit makes an erroneous determination as a result of laser light that is reflected by a highly reflective object present near the laser radar apparatus entering inside the casing, and improving determination accuracy of the contamination detection.

Embodiments of the present disclosure will hereinafter be described with reference to the drawings.

A laser radar apparatus 1 according to the present embodiment is mounted to a vehicle. In addition, for example, the laser radar apparatus 1 may emit laser light ahead of the vehicle and detects reflected laser light, thereby detecting at least a distance to an object present ahead of the vehicle.

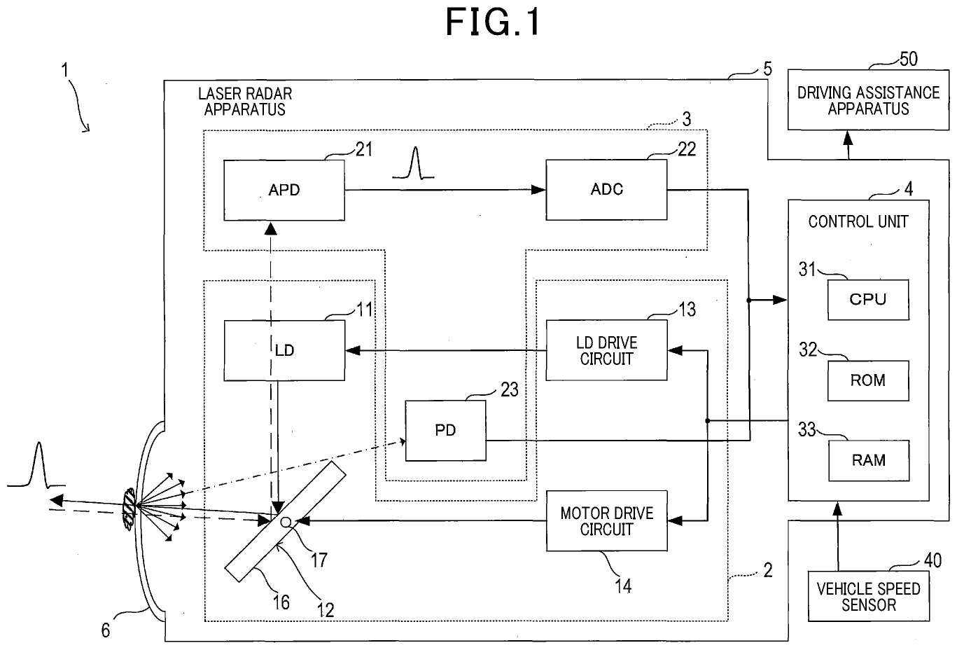

As shown in FIG. 1, the laser radar apparatus 1 includes a light projecting unit 2, a light receiving unit 3, a control unit 4, a casing 5, and an optical window 6. The casing 5 is a box-shaped body having an opening portion that transmits light. The light projecting unit 2, the light receiving unit 3, and the control unit 4 are housed inside the casing 5. The optical window 6 is formed of a material that transmits light and is set to seal the opening portion of the casing 5.

The light projecting unit 2 emits laser light toward the optical window 6 within a scanning angle range that is set in advance. The light projecting unit 2 includes a laser diode 11, a scanning unit 12, a laser-diode drive circuit 13, and a motor drive circuit 14. The laser diode 11 emits pulsed laser light. The scanning unit 12 scans the laser light over the above-described scanning angle range by oscillating a mirror 16 that reflects the laser light around a rotation shaft 17 provided in the mirror 16 by a drive force that is generated by a motor (not shown). The laser-diode drive circuit 13 outputs, to the laser diode 11, a drive signal for emitting light from the laser diode 11 based on an instruction from the control unit 4. The motor drive circuit 14 outputs, to the motor, a drive signal for generating the drive force for rotating the mirror 16 based on an instruction from the control unit 4.

The light receiving unit 3 includes an avalanche photodiode 21, an analog-to-digital (AD) converter 22, and a photodiode 23. The avalanche photodiode 21 detects the laser light that enters from the optical window 6 and is reflected by the mirror 16. The AD converter 22 converts a voltage value of an analog signal that is inputted from the avalanche photodiode 21 to a digital value and outputs, to the control unit 4, a conversion signal that indicates the converted digital value. The photodiode 23 is set near the optical window 6. As a result, the photodiode 23 detects the laser light that is emitted from the mirror 16 toward the optical window 6 and reflected at the optical window 6. The photodiode 23 outputs, to the control unit 4, a light detection signal that is obtained by detecting the laser light.

The control unit 4 is an electronic control apparatus that is mainly configured by a microcomputer that includes a central processing unit (CPU) 31, a read-only memory (ROM) 32, a random access memory (RAM) 33, and the like. Various functions of the microcomputer are actualized by the CPU 31 running a program stored in a non-transitory computer-readable (tangible) storage medium. In this example, the ROM 32 corresponds to the non-transitory computer-readable (tangible) storage medium in which the program is stored. In addition, a method corresponding to the program is performed as a result of the program being run. Here, a portion or all of functions provided by the CPU 31 may be configured by hardware by a single or plurality of integrated circuits (ICs) and the like. Furthermore, the control unit 4 may be configured by a single or plurality of microcomputers.

The control unit 4 measures a distance to a location (hereafter, a distance measurement point) at which the pulsed laser light is reflected, based on a difference between a time at which the laser diode 11 emits the pulsed laser light and a time at which the avalanche photodiode 21 detects the pulsed laser light. In addition, the control unit 4 measures an orientation angle of the distance measurement point based on a scanning angle of the mirror 16 when the pulsed laser light is emitted.

Furthermore, the control unit 4 generates distance-measurement point information indicating the distance to the distance measurement point, the orientation angle, and light reception intensity (that is, intensity of the laser light detected by the avalanche photodiode 21) for each detected distance measurement point, and stores the generated distance-measurement point information in the RAM 33. In addition, for example, the control unit 4 may output the generated distance-measurement point information to a driving assistance apparatus 50 that performs driving assistance.

Furthermore, every time the laser diode 11 emits the pulsed laser light, the control unit 4 acquires the light detection signal from the photodiode 23 and stores, in the RAM 33 as scattered light information, a maximum value (hereafter, a scattered-light voltage value) of a voltage of the light detection signal and a scanning angle when the light detection signal from the photodiode 23 is acquired.

In addition, the control unit 4 continuously acquires the conversion signal from the AD converter 22 during a period (hereafter, a non-light emission period) in which the laser diode 11 is not emitting the pulsed laser light, and calculates an average value of a detection voltage of the avalanche photodiode 21. Then, the control unit 4 stores the average value in the RAM 33 as non-light emission voltage information.

The vehicle to which the laser radar apparatus 1 is mounted includes a vehicle speed sensor 40 that detects a traveling speed (hereafter, a vehicle speed) of the vehicle. The vehicle speed sensor 40 outputs, to the control unit 4, a vehicle-speed detection signal that indicates the detected vehicle speed.

Next, steps of a window-surface contamination detection process performed by the control unit 4 will be described. The window-surface contamination detection process is a process that is repeatedly performed during the operation of the laser radar apparatus 1.

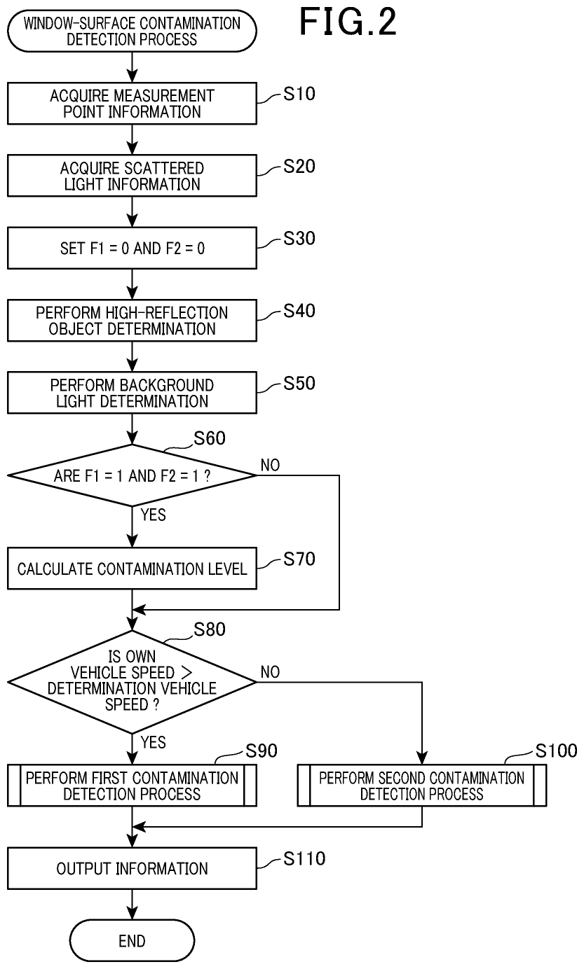

When the window-surface contamination detection process is performed, as shown in FIG. 2, first, at step S10, the CPU 31 of the control unit 4 acquires, from the RAM 33, a single or plurality of sets of distance-measurement point information that is newly generated by the control unit 4 during a period from the end of the process at step S10 in a previous window-surface contamination detection process to a current point.

In addition, at step S20, the CPU 31 acquires, from the RAM 33, the scattered light information that is newly generated by the control unit 4 during the period from the end of the process at step S10 in the previous window-surface contamination detection process to the current point.

Furthermore, at step S30, the CPU 31 clears a highly reflective object determination-allowed flag F1 and a background-light determination-allowed flag F2 that are provided in the RAM 33. In the description hereafter, the flag being set refers to a value of the flag being set to 1. The flag being cleared refers to the value of the flag being set to 0.

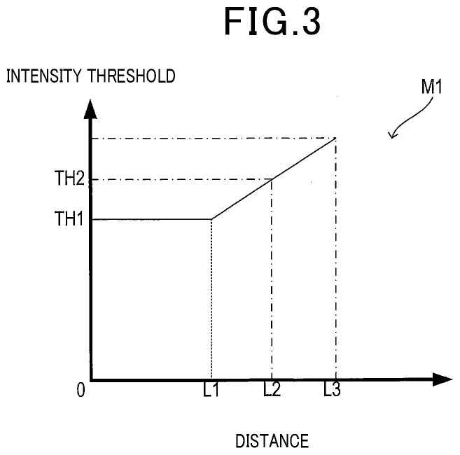

Then, at step S40, the CPU 31 performs a highly reflective object determination. Specifically, first, the CPU 31 extracts information that indicates the distance of the distance measurement point for each of the single or plurality of sets of distance-measurement point information acquired at step S10, and sets an intensity threshold with reference to an intensity threshold map M1 that is stored in the ROM 32. As shown in FIG. 3, the threshold map M1 sets a corresponding relationship between the distance and the intensity threshold. In the threshold map M1 shown in FIG. 3, the intensity threshold is set to TH1 when the distance is 0 to L1. In addition, when the distance is L1 to L3, the intensity threshold gradually increases as the distance increases, and the intensity threshold is set to a maximum value when the distance is L3. For example, the intensity threshold when the distance is L2 may be TH2.

Then, the CPU 31 extracts the light reception intensity for each of the plurality of sets of distance-measurement point information, and determines whether the extracted light reception intensity is equal to or less than the intensity threshold set for the corresponding distance-measurement point information. Furthermore, when the light reception intensity is less than the intensity threshold for all sets of distance-measurement point information, the CPU 31 sets the highly reflective object determination-allowed flag F1. Meanwhile, when the light reception intensity is equal to or greater than the intensity threshold for at least one set of distance-measurement point information, the CPU 31 clears the highly reflective object determination-allowed flag F1.

When the process at step S40 is ended, as shown in FIG. 2, at step S50, the CPU 31 performs background light determination. Specifically, first, the CPU 31 acquires newest non-light emission voltage information from a single or plurality of sets of non-light emission voltage information stored in the RAM 33. Then, the CPU 31 determines whether the voltage value that is indicated by the acquired non-light emission voltage information is equal to or greater than a background-light determination value that is set in advance.

Here, when the voltage value indicated by the non-light emission voltage information is less than the background-light determination value, the CPU 31 sets the background-light determination-allowed flag F2. Meanwhile, when the voltage value indicated by the non-light emission voltage information is equal to or greater than the background-light determination value, the CPU 31 clears the background-light determination-allowed flag F2.

When the process at step S50 is ended, at step S60, the CPU 31 determines whether the highly reflective object determination-allowed flag F1 is set and the background-light determination-allowed flag F2 is set. Here, when at least either of the highly reflective object determination-allowed flag F1 and the background-light determination-allowed flag F2 is cleared, the CPU 31 proceeds to step S80.

Meanwhile, when the highly reflective object determination-allowed flag F1 is set and the background-light determination-allowed flag F2 is set, at step S70, the CPU 31 calculates a contamination level L and proceeds to step S80.

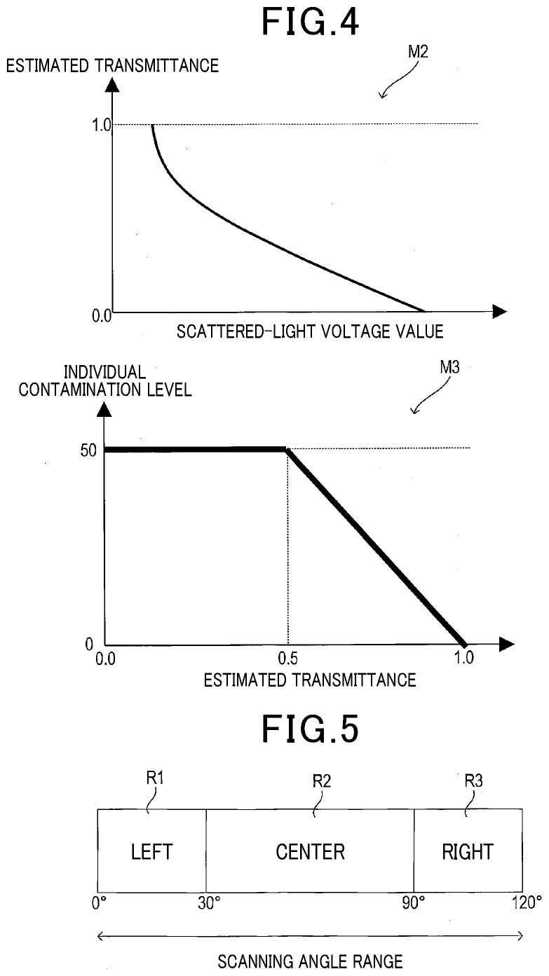

Specifically, first, the CPU 31 extracts the scattered-light voltage value for each of the single or plurality of sets of scattered light information acquired at step S20, and sets an estimated transmittance with reference to a transmittance map M2 that is stored in the ROM 32. As shown in FIG. 4, the transmittance map M2 sets a corresponding relationship between the scattered-light voltage value and the estimated transmittance. The transmittance map M2 is set to have a negative correlation between the scattered-light voltage value and the estimated transmittance. The transmittance map M2 is generated by the transmittance of the optical window 6 and the scattered-light voltage value being measured by a plurality of known contaminants each being attached to the optical window 6.

Next, for each estimated transmittance that is set, the CPU 31 sets an individual contamination level with reference to a contamination level map M3 that is stored in the ROM 32. The contamination level map M3 sets a corresponding relationship between the estimated transmittance and the individual contamination level. In the contamination level map M3 shown in FIG. 4, the individual contamination level is set to 50 when the estimated transmittance is 0 to 0.5. In addition, when the estimated transmittance is 0.5 to 1.0, the individual contamination level gradually decreases as the estimated transmittance increases, and the individual contamination level is set to 0 when the estimated transmittance is 1.0.

Then, the CPU 31 calculates a first region contamination-level average μ1, a second region contamination-level average μ2, and a third region contamination-level average μ3 of each of a first region R1, a second region R2, and a third region R3 that are set by the scanning angle range being divided into three as shown in FIG. 5, and stores the first region contamination-level average μ1, the second region contamination-level average μ2, and the third region contamination-level average μ3 in the RAM 33. For example, the first region R1 is a region in which the scanning angle may be 0° to 30°. For example, the second region R2 is a region in which the scanning angle may be 30° to 90°. For example, the third region R3 is a region in which the scanning angle may be 90° to 120°.

The first region contamination-level average μ1 is an average value of the individual contamination level of which the corresponding scanning angle is included in the first region R1, among a single or plurality of individual contamination levels that are set based on the single or plurality of sets of scattered light information acquired at step S20.

The second region contamination-level average μ2 is an average value of the individual contamination level of which the corresponding scanning angle is included in the second region R2, among a single or plurality of individual contamination levels that are set based on the single or plurality of sets of scattered light information acquired at step S20.

The third region contamination-level average μ3 is an average value of the individual contamination level of which the corresponding scanning angle is included in the third region R3, among a single or plurality of individual contamination levels that are set based on the single or plurality of sets of scattered light information acquired at step S20.

Furthermore, the CPU 31 calculates a first region contamination level L1, a second region contamination level L2, and a third region contamination level L3.

The first region contamination level L1 is an average value of a plurality of first region contamination-level averages μ1 calculated within a most recent five-second period. The second region contamination level L2 is an average value of a plurality of second region contamination-level averages μ2 calculated within the most recent five-second period. The third region contamination level L3 is an average value of a plurality of third region contamination-level averages μ3 calculated within the most recent five-second period.

Then, the CPU 31 stores, in the RAM 33, a maximum value of the calculated first region contamination level L1, second region contamination level L2, and third region contamination level L3 as the contamination level L.

As shown in FIG. 2, upon proceeding to step S80, the CPU 31 acquires the vehicle-speed detection signal from the vehicle speed sensor 40 and determines whether the vehicle speed (hereafter, an own vehicle speed) indicated by the vehicle-speed detection signal exceeds a determination vehicle speed (for example, 5 km/h) that is set in advance.

Here, when the own vehicle speed exceeds the determination vehicle speed, at step S90, the CPU 31 performs a first contamination detection process described hereafter and proceeds to step S110. Meanwhile, when the own vehicle speed is equal to or less than the determination vehicle sped, at step S100, the CPU 31 performs a second contamination detection process described hereafter and proceeds to step S110.

Upon proceeding to step S110, the CPU 31 outputs, to the driving assistance apparatus 50, contamination level information that indicates the contamination level L, and contamination detection information that indicates whether a contamination detection flag F3, described hereafter, is set or cleared, and ends the window-surface contamination detection process.

Next, steps in the first contamination detection process performed at step S90 will be described.

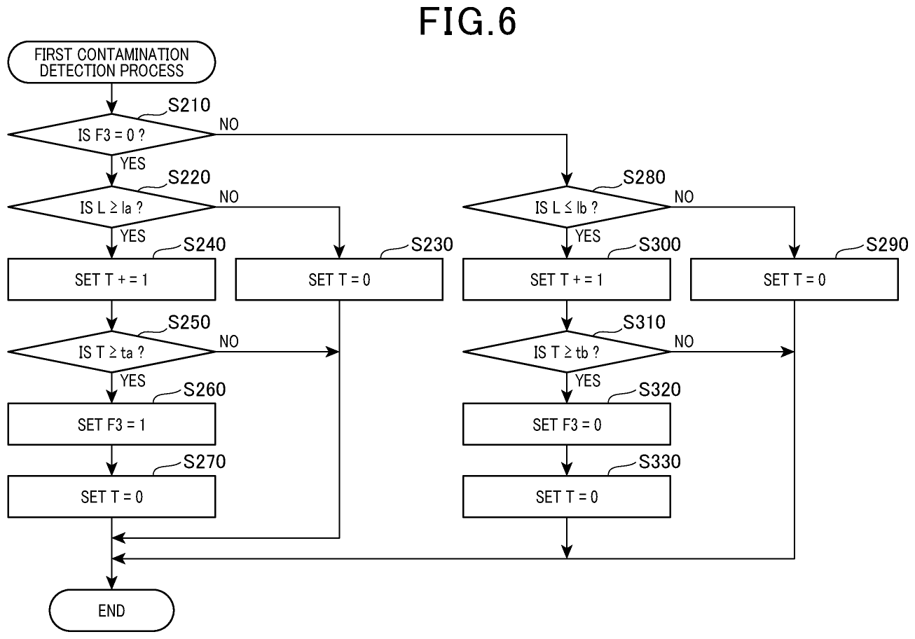

When the first contamination detection process is performed, as shown in FIG. 6, first, at step S210, the CPU 31 of the control unit 4 determines whether the contamination detection flag F3 provided in the RAM 33 is cleared. Here, when the contamination detection flag F3 is cleared, the CPU 31 determines whether the contamination level L is equal to or greater than a contamination attachment level la (such as 30) that is set in advance.

Here, when the contamination level L is less than the contamination attachment level la, at step S230, the CPU 31 sets a value of a duration counter T that is provided in the RAM 33 to 0 and ends the first contamination detection process.

Meanwhile, when the contamination level L is equal to or greater than the contamination attachment level la, at step S240, the CPU 31 increments the duration counter T (that is, adds 1). Then, at step S250, the CPU 31 determines whether a value of the duration counter T is equal to or greater than an attachment-confirmation determination value ta (such as a value corresponding to 10 seconds) that is set in advance.

Here, when the value of the duration counter T is less than the attachment-confirmation determination value Ta, the CPU 31 ends the first contamination detection process. Meanwhile, when the value of the duration counter T is equal to or greater than the attachment-confirmation determination value ta, at step S260, the CPU 31 sets the contamination detection flag F3. Furthermore, at step S270, the CPU 31 sets the value of the duration counter T to 0 and ends the first contamination detection process.

In addition, when the contamination detection flag F3 is set at step S210, at step S280, the CPU 31 determines whether the contamination level L is equal to or less than a no-contamination level lb (such as 5) that is set in advance.

Here, when the contamination level L exceeds the no-contamination level lb, at step S290, the CPU 31 sets the value of the duration counter T to 0 and ends the first contamination detection process.

Meanwhile, when the contamination level L is equal to or less than the no-contamination level lb, at step S300, the CPU 31 increments the duration counter T. Then, at step S310, the CPU 31 determines whether the value of the duration counter T is equal to or greater than a cancellation-confirmation determination value tb (such as a value corresponding to 20 seconds) that is set in advance.

Here, when the value of the duration counter T is less than the cancellation-confirmation determination value tb, the CPU 31 ends the first contamination detection process. Meanwhile, when the value of the duration counter T is equal to or greater than the cancellation-confirmation determination value tb, at step S320, the CPU 31 clears the contamination detection flag F3. Furthermore, at step S330, the CPU 31 sets the value of the duration counter T to 0 and ends the first contamination detection process.

Next, steps in the second contamination detection process performed at step S100 will be described.

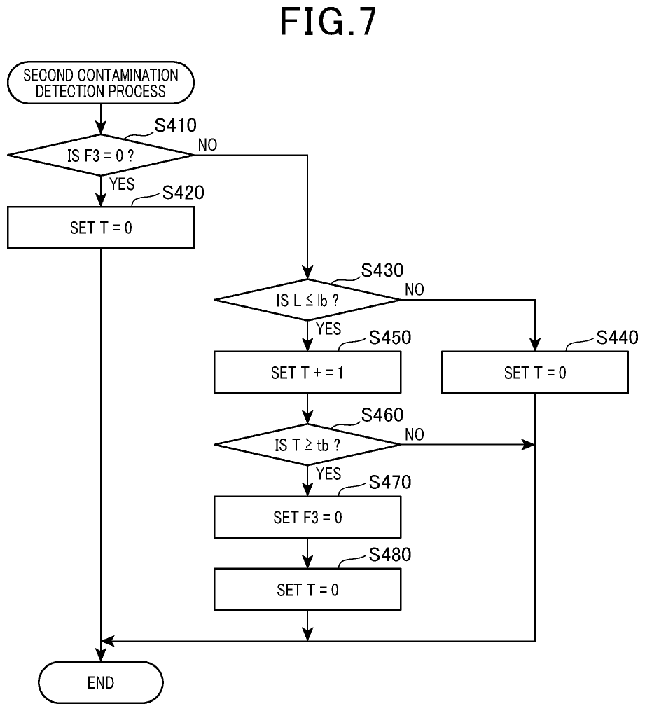

When the second contamination detection process is performed, as shown in FIG. 7, first, at step S410, the CPU 31 of the control unit 4 determines whether the contamination detection flag F3 provided in the RAM 33 is cleared. Here, when the contamination detection flag F3 is cleared, at step S420, the CPU 31 sets the value of the duration counter T to 0 and ends the second contamination detection process.

Meanwhile, when the contamination detection process flag F3 is set, at step S430, the CPU 31 determines whether the contamination level L is equal to or less than the no-contamination level lb.

Here, when the contamination level L exceeds the no-contamination level lb, at step S440, the CPU 31 sets the value of the duration counter T to 0 and ends the second contamination detection process.

Meanwhile, when the contamination level L is equal to or less than the no-contamination level lb, at step S450, the CPU 31 increments the duration counter T. Then, at step S460, the CPU 31 determines whether the value of the duration counter T is equal to or greater than the cancellation-confirmation determination value tb.

Here, when the value of the duration counter T is less than the cancellation-confirmation determination value tb, the CPU 31 ends the second contamination detection process. Meanwhile, when the value of the duration counter T is equal to or greater than the cancellation-confirmation determination value tb, at step S470, the CPU 31 clears the contamination detection flag F3. Furthermore, at step S480, the CPU 31 sets the value of the duration counter T to 0 and ends the second contamination detection process.

The control unit 4 that is configured in this manner acquires the distance-measurement point information from the laser radar apparatus 1. The laser radar apparatus 1 emits laser light toward the outside by transmitting the laser light through the optical window 6 from inside the casing 5. The laser radar apparatus 1 then detects the laser light that arrives inside the casing 5 after being reflected at the distance measurement point, and thereby generates the distance-measurement point information that indicates a distance-measurement point distance that is the distance to the distance measurement point and the light reception intensity that is the intensity of the detected laser light.

In addition, the control unit 4 acquires the scattered light information that indicates scattered light intensity of scattered light from the photodiode 23 that detects the scattered light that is generated by the laser light being scattered inside the casing 5 as a result of emission of the laser light by the laser radar apparatus 1.

Furthermore, the control unit 4 calculates the contamination level L that indicates the extent of contamination on the optical window 6 based on the scattered light intensity indicated by the scattered light information.

In addition, the control unit 4 prohibits calculation of the contamination level L when the light reception intensity is equal to or greater than the intensity threshold that is set based on the distance-measurement point distance corresponding to the light reception intensity.

Furthermore, the control unit 4 prohibits calculation of the contamination level L when the voltage value indicated by the non-light emission voltage information is equal to or greater than the background-light determination value.

The control unit 4 such as this is capable of suppressing the occurrence of a situation in which the contamination level L is erroneously calculated as a result of laser light that is reflected by a highly reflective object that is present near the laser radar apparatus 1 entering inside the casing 5, and improving determination accuracy of the contamination detection.

In addition, the control unit 4 is capable of suppressing the occurrence of a situation in which the contamination level L is erroneously calculated as a result of background light entering inside the casing 5 from outside the casing 5, and improving determination accuracy of the contamination detection.

Furthermore, the control unit 4 determines a transition between an attached state (that is, a state in which the contamination detection flag F3 is set) in which a contaminant is attached to the optical window 6 and a non-attached state (that is, a state in which the contamination detection flag F3 is cleared) in which a contaminant is not attached to the optical window 6, based on the contamination level L. Then, the control unit 4 determines whether the own vehicle speed is equal to or less than the determination vehicle speed set in advance. When the own vehicle speed is equal to or less than the determination vehicle speed, the control unit 4 prohibits the determination of the transition from the non-attached state to the attached state.

As a result, the control unit 4 can suppress the occurrence of a situation in which the state is erroneously determined to be the attached state as a result of an obstacle being present near the laser radar apparatus 1 during stopping of the vehicle to which the laser radar apparatus 1 is mounted.

According to the embodiment described above, the control unit 4 corresponds to a contamination detection apparatus. Step S10 corresponds to a process as a distance-measurement point information acquiring unit. The photodiode 23 corresponds to a scattered light sensor. Step S20 corresponds to a process as a scattered-light information acquiring unit.

In addition, step S70 corresponds to a process as a contamination detection unit. Steps S40 and S60 correspond to a process as an intensity prohibiting unit.

Furthermore, the voltage value of the non-light emission voltage information being equal to or less than the background-light determination value corresponds to a background-light prohibiting condition. Steps S50 and S60 correspond to a process as a background-light prohibiting unit.

In addition, step S90 corresponds to a process as a state determining unit. Step S80 corresponds to a process as a transition prohibiting unit. The determination vehicle speed corresponds to a return determination prohibiting speed.

Furthermore, steps S220 to S270 corresponds to a process as an attached-state determining unit. The contamination attachment level la corresponds to an attached-state determination value. The attachment-confirmation determination value to corresponds to an attached-state determination time.

In addition, steps S280 to S330 corresponds to a process as a non-attached state determining unit. The no-contamination level lb corresponds to a non-attached state determination value. The cancellation-confirmation determination value corresponds to a non-attached state determination time. Step S110 corresponds to a process as a contamination-level output unit.

An embodiment of the present disclosure is described above. However, the present disclosure is not limited to the above-described embodiment. Various modifications are possible.

### First Modification

According to the above-described embodiment, an example in which the contamination level L is calculated is described. However, an example in which whether the optical window 6 is contaminated is determined is also possible.

### Second Modification

According to the above-described embodiment, an example in which the background light determination is performed based on the value of the detection voltage of the avalanche photodiode 21 during the non-light emission period is given. However, the background light determination may be performed based on a value of a voltage (that is, a base voltage) before a rising edge or after a falling edge of the pulsed laser light detected by the avalanche photodiode 21.

The control unit 4 and the method thereof described in the present disclosure may be actualized by a dedicated computer that is provided such as to be configured by a processor and a memory, the processor being programmed to provide a single or a plurality of functions that are realized by a computer program. Alternatively, the control unit 4 and the method thereof described in the present disclosure may be actualized by a dedicated computer that is provided by a processor being configured by a single or a plurality of dedicated hardware logic circuits. Alternatively, the control unit 4 and the method thereof described in the present disclosure may be actualized by one or more dedicated computers that are configured by a combination of a processor that is programmed to provide a single or a plurality of functions, a memory, and a processor that is configured by one or more hardware logic circuits. In addition, the computer program may be stored in a non-transitory computer-readable (tangible) storage medium that can be read by a computer as instructions performed by the computer. A method for actualizing the functions of each section included in the control unit 4 is not necessarily required to include software. All of the functions may be actualized through use of a single or a plurality of pieces of hardware.

A plurality of functions provided by a single constituent element according to the above-described embodiments may be actualized by a plurality of constituent elements. A single function provided by a single constituent element may be actualized by a plurality of constituent elements. In addition, a plurality of functions provided by a plurality of constituent elements may be actualized by a single constituent element. A single function provided by a plurality of constituent elements may be actualized by a single constituent element. Furthermore, a part of a configuration according to the above-described embodiment may be omitted. Moreover, at least a part of a configuration according to an above-described embodiment may be added to or replace a configuration according to another of the above-described embodiments.

The present disclosure can also be actualized by various modes in addition to the above-described control unit 4, such as a system in which the control unit 4 is a constituent element, a program for enabling a computer to function as the control unit 4, a non-transitory computer-readable (tangible) storage medium such as a semiconductor memory that records the program therein, and a contamination detection method.

What is claimed is:

1. A contamination detection apparatus comprising:
a distance-measurement point acquiring unit that is configured to acquire distance-measurement point information from a laser radar apparatus that is configured to: emit laser light toward outside by transmitting the laser light through an optical window from inside a casing; detect the laser light that arrives inside the casing after being reflected at a distance measurement point; and generate the distance-measurement point information that indicates a distance-measurement point distance that is a distance to the distance measurement point and light reception intensity that is intensity of the detected laser light;
a scattered-light information acquiring unit that is configured to acquire scattered light information that indicates scattered light intensity of scattered light from a scattered light sensor that is configured to detect scattered light that is generated by the laser light scattering inside the casing as a result of emission of the laser light by the laser radar apparatus;
a contamination detection unit that is configured to execute contamination detection that detects contamination of the optical window based on the scattered light intensity indicated by the scattered light information; and
an intensity prohibiting unit that is configured to prohibit the contamination detection unit from executing the contamination detection when the light reception intensity is equal to or greater than an intensity threshold that is set based on the distance-measurement point distance corresponding to the light reception intensity.

2. The contamination detection apparatus according to claim 1, further comprising:
a background-light prohibiting unit that is configured to determine whether a background-light prohibiting condition is met, the background-light prohibiting condition being set in advance and indicating that an amount of background light entering inside the casing from the outside is large, and prohibit the contamination detection unit from executing the contamination detection when the background-like prohibiting condition is met.

3. The contamination detection apparatus according to claim 2, further comprising:
a state determining unit that is configured to determine transition between an attached state in which a contaminant is attached to the optical window and a non-attached state in which a contaminant is not attached to the optical window, based on a determination result from the contamination detection unit; and
a transition prohibiting unit that is configured to determine whether a traveling speed of a vehicle to which the laser radar apparatus is mounted is equal to or less than a return determination prohibiting speed that is set in advance, and prohibit the state determining unit from determining the transition from the non-attached state to the attached state when the traveling speed is equal to or less than the return determination prohibiting speed.

4. The contamination detection apparatus according to claim 3, wherein:
the contamination detection unit is configured to calculate a contamination level that indicates an extent of contamination of the optical window as the contamination detection.

5. The contamination detection apparatus according to claim 4, further comprising:
an attached-state determining unit that is configured to determine that a state is an attached state in which a contaminant is attached to the optical window, when a state in which the contamination level is equal to or greater than an attached-state determination value that is set in advance continues for an attached-state determination time that is set in advance or more.

6. The contamination detection apparatus according to claim 5, further comprising:
a non-attached state determining unit that is configured to determine that a state is a non-attached state in which a contaminant is not attached to the optical window, when the state in which the contamination level is equal to or less than a non-attached state determination value that is set in advance continues for a non-attached state determination time that is set in advance or more.

7. The contamination detection apparatus according to claim 6, further comprising:
a contamination-level outputting unit that is configured to output contamination level information that indicates the contamination level calculated by the contamination detection unit.

8. The contamination detection apparatus according to claim 1, further comprising:
a state determining unit that is configured to determine transition between an attached state in which a contaminant is attached to the optical window and a non-attached state in which a contaminant is not attached to the optical window, based on a determination result from the contamination detection unit; and
a transition prohibiting unit that is configured to determine whether a traveling speed of a vehicle to which the laser radar apparatus is mounted is equal to or less than a return determination prohibiting speed that is set in advance, and prohibit the state determining unit from determining the transition from the non-attached state to the attached state when the traveling speed is equal to or less than the return determination prohibiting speed.

9. The contamination detection apparatus according to claim 1, wherein:
the contamination detection unit is configured to calculate a contamination level that indicates an extent of contamination of the optical window as the contamination detection.

10. The contamination detection apparatus according to claim 9, further comprising:
an attached-state determining unit that is configured to determine that a state is an attached state in which a contaminant is attached to the optical window, when a state in which the contamination level is equal to or greater than an attached-state determination value that is set in advance continues for an attached-state determination time that is set in advance or more.

11. The contamination detection apparatus according to claim 9, further comprising:
a non-attached state determining unit that is configured to determine that a state is a non-attached state in which a contaminant is not attached to the optical window, when the state in which the contamination level is equal to or less than a non-attached state determination value that is set in advance continues for a non-attached state determination time that is set in advance or more.

12. The contamination detection apparatus according to claim 9, further comprising:
a contamination-level outputting unit that is configured to output contamination level information that indicates the contamination level calculated by the contamination detection unit.

13. A contamination detection system comprising:
a processor;
a non-transitory computer-readable storage medium; and
a set of computer-executable instructions stored in the computer-readable storage medium that, when read and executed by the processor, cause the processor to implement:
acquiring distance-measurement point information from a laser radar apparatus that is configured to: emit laser light toward outside by transmitting the laser light through an optical window from inside a casing; detect the laser light that arrives inside the casing after being reflected at a distance measurement point; and generate the distance-measurement point information that indicates a distance-measurement point distance that is a distance to the distance measurement point and light reception intensity that is intensity of the detected laser light;
acquiring scattered light information that indicates scattered light intensity of scattered light from a scattered light sensor that is configured to detect scattered light that is generated by the laser light scattering inside the casing as a result of emission of the laser light by the laser radar apparatus;
executing contamination detection that detects contamination of the optical window based on the scattered light intensity indicated by the scattered light information; and
prohibiting execution of the contamination detection when the light reception intensity is equal to or greater than an intensity threshold that is set based on the distance-measurement point distance corresponding to the light reception intensity.

14. A contamination detection method comprising:
acquiring distance-measurement point information from a laser radar apparatus that is configured to: emit laser light toward outside by transmitting the laser light through an optical window from inside a casing; detect the laser light that arrives inside the casing after being reflected at a distance measurement point; and generate the distance-measurement point information that indicates a distance-measurement point distance that is a distance to the distance measurement point and light reception intensity that is intensity of the detected laser light;
acquiring scattered light information that indicates scattered light intensity of scattered light from a scattered light sensor that is configured to detect scattered light that is generated by the laser light scattering inside the casing as a result of emission of the laser light by the laser radar apparatus;
executing contamination detection that detects contamination of the optical window based on the scattered light intensity indicated by the scattered light information; and
prohibiting execution of contamination detection when the light reception intensity is equal to or greater than an intensity threshold that is set based on the distance-measurement point distance corresponding to the light reception intensity.
